(19) United States
(12) Patent Application Publication
(10) Pub. No.: US 2007/0290827 A1
(43) Pub. Date: Dec. 20, 2007

(54) Seat belt activation-vehicle equipment (SAVE)

(76) Inventor: William H. Farrar, Hideaway, TX (US)

Correspondence Address: William H. Farrar, 1432 Tanglewood Dr. W., Hideaway, TX, 75771, US

(21) Appl. No.: 11/810,411

(22) Filed: Jun. 5, 2007

Related U.S. Application Data
(60) Provisional application No. 60/811,078, filed on Jun. 6, 2006.

(51) Int. Cl. B60Q 1/00

(52) U.S. Cl. 340/457.1

(57) ABSTRACT

The SAVE system includes two subsystems: INTERROGATOR and MONITOR. The INTERROGATOR is a send/receive unit (installed in law enforcement vehicles) which, when initiated, emits a signal which is then received by the MONITOR. The signal turns on the MONITOR unit and checks to see if (1) there is a MONITOR system on board, (2) If yes, whether it is operable, and (3) whether the seatbelts in the target vehicle are being appropriately used. A signal is then sent back to the INTERROGATOR which indicates the status of the seatbelt subsystem in the targeted vehicle.

### CROSS REFERENCE TO RELATED APPLICATIONS

This application claims the benefit of provisional patent application Ser. No. US60/811,078, Filed 2006 Jun. 9 by the present inventor.

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to a sensing system that remotely monitors whether vehicle occupants are utilizing their restraint system.

2. Prior Art

According to NHTSA, in 2005, a total of 42,200 people died in motor vehicle accidents on the nation's highways. There were also some 2.68 million injuries also caused by these accidents, of which, over 300,000 were considered incapacitating. Though there are numerous causes of these Crashes, one of the most significant (and preventable), is failure to utilize safety belts in the

NHTSA has stated that seatbelt usage is at 82% nationwide. It should be noted though that these figures are based on simple observation, personal reporting, and inferential statistics. A quick look at the statistics of seatbelt usage notes that some 55% of those killed that year were not wearing seatbelts. The unbelted figure comes to over 23,000, of which, it is estimated that as high as ½ (or 10,000+) of those might have lived if they had availed themselves of restraints.

Data is also available to indicate that a majority of those who received serious injuries were unbelted and, would have probably received less incapacitating injuries had they been wearing seat belts. Additionally, the less seriously injured numbers would also have been substantially reduced.

The results can be devastating to individuals, their families, and other segments of our society. It is estimated that the cost to society as a result of MVAs in 2005 was some 230.6 billion dollars or about $820 for every man, woman, and child in the U.S. This involves losses at the personal level, by employers, increased need for municipal services, by insurance companies, and in many other areas. In terms of injuries, it is estimated that hospital costs for unbelted crash victims are 50% higher than those for ones who are restrained.

In Texas, the story is much the same. In 2003, there were some 2,736 MVA fatalities, of which 1313 (47%) were unrestrained, 1,630 lives were saved by seat belts, and another 494 Individuals could have been saved if they had been wearing a seatbelt. Statistics regarding incapacitating injuries also follows the national figures in terms of reduction of injuries if seatbelts had been used. The estimated cost of these injuries was over $5 million. The federal government is currently offering incentives to states that significantly reduce the percentage of vehicle occupants not using seat belts. Unfortunately, the standards by which they are graded are based on observation and statistical inference. Even though many of the states show significant improvement in percentage of use over the years, the fact remains that approximately 55% of those injured or killed in MVAs were not wearing restraints.

Effective enforcement of seatbelt usage is at best marginal. There are only three ways to ascertain actual numerical or percentage usage: (1) occurrence of a reported MVA, (2) a vehicle is stopped for another violation and non-usage is noted, or (3) an officer happens to notice non-usage. If there were a way to substantially increase the ability of law enforcement to detect non-usage, there would most likely cause a concurrent drop in traffic fatalities and injuries.

I am proposing a system (SAVE) by which a law enforcement officer can remotely detect whether seatbelts are being worn in a vehicle. A sub-system unit (MONITOR) would be installed in all new cars produced in the U.S. and retrofitted to import units prior to sale in this country. Law enforcement vehicles would be fitted with a second sub-system device (INTERROGATOR) to turn on the targeted vehicle device and get an indication whether seatbelts were being worn or not. Units could be designed to monitor the seats for the driver, the front seat occupant, and/or all seats in the vehicle. This could be accomplished by the installation of pressure switches in the seats to tell the system whether there was a person was sitting in a seat or not. Pressure switches could be utilized to be as sensitive to as little as the weight of a small child or baby in a car seat.

The INTERROGATOR would have a very limited range so as to be able to discriminate individual vehicles from one another. There is also the possibility that in the final production model, the outgoing INTERROGATOR signal would also have to be narrow/coherent to improve discrimination. Additionally, if this proved to be the case, a separate small target antenna might have to be installed on each vehicle to receive the incoming signal from the patrol car. Otherwise, the outgoing signal could be transmitted via the car antenna.

The initial signal from the INTERROGATOR unit would turn on the MONITOR and a signal would immediately be sent back to the patrol vehicle, indicating whether there was an operating MONITOR system on board and whether the seatbelts were being utilized or not. Disabling a system on a vehicle type known to have had one installed would yield an indication that there was not a unit on board, a potential violation under the proposed system.

The continuing operation of the system in the vehicle could become part of the regular annual inspection. A check unit similar to that used in patrol cars (but of lower power) would be used by inspection stations to determine operability. Cost of the vehicle MONITOR, INTERROGATOR, and the inspection check system would be minimal (Approximately $25, 200, and $150, respectively) and would be relatively maintenance-free.

There is the question of possibly retrofitting older vehicles with the system but it appears that any previously mandated safety standards have not required retrofitting older units. SAVE would have to have overwhelming acceptance by a large contingent of the population in order to have it installed in all vehicles. Additionally, while it could be accomplished, the level of logistics involved would be considerable and the program would take several years to complete. This type of system could be used on commercial vehicles including particularly school buses. All of the seats in a bus could be wired in series with one another and non usage would prompt an indication to the bus driver. Failure of the driver to require all seats belts to be fastened would cause him/her to become liable for citations and personal responsibility if injuries occurred as a result.

In order for the system to become completely effective, obviously states that have their seat belt laws as secondary would need to convert them to primary laws. An additional need would be to increase the penalties for non-use violations to make it more effective. It would eventually need to become a federal mandated requirement, much like certain vehicle manufacturing and pollution standards have become. It is projected that with its use, real compliance could approach 80-90% and thereby save numerous lives and much suffering.

Obviously there are going to be “nay sayers” and those who feel that it is an invasion of their personal rights to enable law enforcement to accomplish detection. Some 20-30 years ago, an attempt was made to install an ignition interlock system which required that seat belts(s) be fastened before the car could be started. This proposal for this system was met with public resistance as an invasion on personal privacy. The “nay-sayers” said that they wanted to be able to choose whether they wore their seat belts or not. The SAVE system does not interfere with the starting or operation of the car. The driver (and/or passengers) can opt not to wear their restraints but they also know that without usage, they are violating the law and are prone to officers to do their job. It is worth the unhappiness of a few to save the lives of many and benefit society as a whole.

### BACKGROUND OF INVENTION—OBJECTS AND ADVANTAGES

Accordingly, besides the objects and advantages of the SAVE system described in the above patent, several objects and advantages of the present invention are:

(a) To provide law enforcement with a reliable and accurate means of determining seatbelt usage in all cases monitored;

(b) To provide a direct manner in which to prevent numerous MVA deaths and injuries;

(c) To provide states with an accurate way of determining seatbelt usage;

(d) To reduce overall costs to the public by eliminating numerous preventable crashes;

(e) To provide a means of reducing health cost, making it affordable for more people.

Further objects and advantages will be realized as more vehicles become equipped with these systems over the years including increased revenue to municipalities and increased usage due to public awareness.

### SUMMARY

In order to assist law enforcement officers in accurately ascertaining if occupants in a motor vehicle are wearing their seatbelts, the SAVE system is proposed. It will allow law enforcement to remotely monitor seatbelt usage, thereby, directly impacting the number of MVA

### DRAWINGS—FIGURES

The drawings are pictured as block diagrams and do not include specific circuitry though it should be noted that all electronics involved are “off the shelf” and do not include any new technology. Currently, specific circuitry is being designed by professionals with expertise in that area.

FIG. 1 shows operating system comprising the INTERROGATOR portion of the system which is installed in the law enforcement vehicle.

FIG. 2 shows the operating system comprising the MONITOR portion of the system which is installed in the subject vehicle.

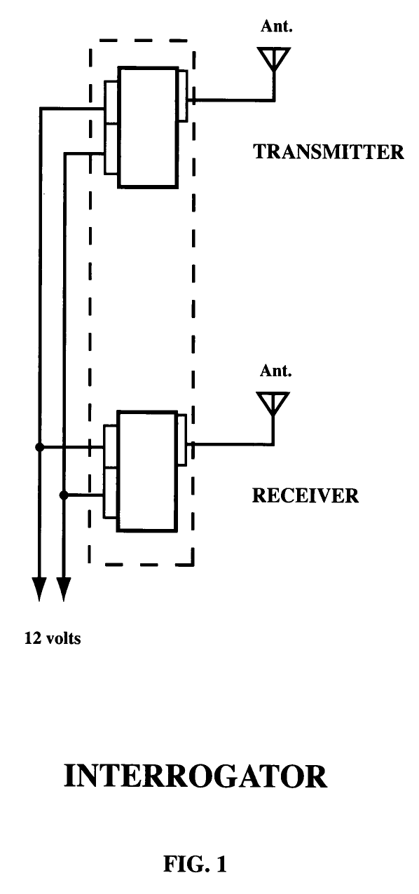

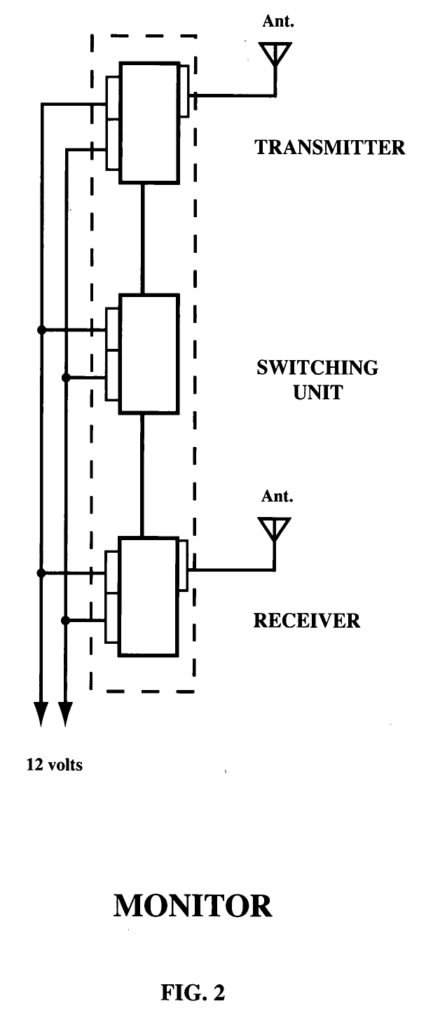

### DETAILED DESCRIPTION—FIGS. 1 and 2—EMBODIMENTS

The INTERROGATOR system is mounted in an aluminum box (to decrease spurious signals from interfering with operation) equipped with suction cups by which it can be attached to the windshield above the dash or it can be mounted by clips to the sun visor. The box has two momentary push buttons (“Initiate” and “Reset”) and two indicator lamps (green labeled “Use/Operation” and red labeled “Inop/Disabled/Non-use.” There is a power cable running from the box two the cigar lighter/power outlet which provides 12 volts DC for operation.

The MONITOR subsystem is also encased in an aluminum box (for the same reasons as the INTERROGATOR and can be mounted under the hood, preferably in a location that is relatively cool because of the sensitivity of electronics to heat. There is a power cable connected to 12 volts DC through a spare fuse in the fuse/breaker panel. There are also two other cables, interconnecting the seat belt interlock and the seat pressure switch systems (if used).

Operation—FIG. 1 & 2

In FIG. 1, the INTERROGATOR unit is mounted on the patrol car's visor or on the dash and the officer presses an “Initiate” button on the unit, which in turn generates a signal which is then emitted by the transmitting antenna directionally toward the target vehicle.

In FIG. 2, the transmitted signal is received at the MONITOR receiver antenna and is then passed on to the receiver circuit which then generates a pulse to the switching circuit. The switching circuit then generates a voltage which passes thru the seatbelt and seat pressure switch circuits and if they are in use appropriately, the switching circuit generates a signal which then travels to the transmitter circuit. A signal is then transmitted back to the INTERROGATOR (FIG. 1) indicating whether the seatbelt is being utilized or not. If the vehicle has an operable system and the seatbelts are being used, a green indicator will illuminate. If the vehicle doesn't have a system, the one it has is non-functional or if seatbelts are not being worn properly, a red indicator will illuminate and the law enforcement officer will take appropriate action.

The lamp indications on the INTERROGATOR will remain lit for validation purposes and then reset by the “Reset” on the panel.

Conclusion, Ramifications, and Scope

With the large number of persons killed and seriously injured each year in MVAS, nearly half of them were not wearing seatbelts. Statistics over the years indicate that a majority of those killed might have survived and the serious injuries sustained would have been far less serious. Effective enforcement of seatbelt laws is less than optimal as the actual violation must be observed under today's laws. Unless a vehicle is stopped for another violation or by chance, when non use is observed from a distance, lack of use will go undetected. Any system that will remotely detect non usage of seat belts when used correctly will certainly be of great benefit to society in that
MVA fatalities can be reduced by more than 50%, which translates into some 12,000 individuals, based on 2005 statistics.
The seriousness of injuries sustained in MVAs can be reduced by at least 50%, thereby requiring less time in the hospital and less invasive procedures, in general.
Lost time for employees can be of benefit the family by reducing time off and the possibility of occurring financial hardship.
Decreased time lost to the employer because of employee injuries translates into monetary savings and increase in production efficiency.
Ultimately, reductions in insurance costs can be realized as a result of reduced demands for medical and life insurance disbursements.
Overall health costs can be reduced due to the fact that hospitals will experience lower costs that they have to absorb due to uninsured patients.
Costs of automobile repairs can be reduced due to a reduced number of MVAs which
The emotional impact and physical pain associated with MVAs can be reduced by simply reducing the number of accidents occurring.

Thus the benefit to our society by being able to detect seatbelt non-usage before accidents occur is incalculable.

I claim:

1. That the SAVE system is a sensing device to be used by law enforcement to remotely determine if seatbelts are being appropriately utilized in motor vehicles. It is basically comprised of two sub systems,
b. The INTERROGATOR sub-system consists of a transit/receive circuit, housed in a metal box, which first transmits a signal to the target vehicle and in turn will receive a signal back as to whether the seatbelt system is being used. The unit receives power from the vehicle's 12 volts battery system via the cigar/power outlet.
c. The MONIOR subsystem, installed at time of production of the vehicle, consists of three circuits: receiver, switching, and transmit. It is also housed in a metal box and is located under the hood. It receives input from the existing seatbelt switch circuit and from the seat pressure switches. It is powered by the vehicle's 12 volt battery system through wiring via an unused fuse in the vehicle's fuse/breaker system.
whereby a law enforcement officer can determine if occupants in a particular vehicle are wearing their restraints and take appropriate action, if warranted.
